(19) United States
(12) Patent Application Publication
(10) Pub. No.: US 2026/0275087 A1
(43) Pub. Date: Sep. 17, 2026

(54) BIOPLASTIC COMPOSITION AND METHOD OF MANUFACTURE THEREOF

(71) Applicant: BIOLABMATE COMPOSITE INC., St. John’s (CA)

(72) Inventors: Sarika KUMARI, St. John’s (CA); Sanjay DUBEY, St. John’s (CA)

(21) Appl. No.: 19/563,136

(22) Filed: Mar. 11, 2026

Related U.S. Application Data
(60) Provisional application No. 63/770,458, filed on Mar. 12, 2025.

(51) Int. Cl. C08L 5/04; C08K 5/00; C08K 5/11; C08K 7/02; C08K 11/00

(52) U.S. Cl. CPC C08L 5/04; C08K 5/0016; C08K 5/11; C08K 7/02; C08K 11/00

(57) ABSTRACT

A thermoplastic water-free solvent-free bioplastic composition is provided. This composition comprises a seaweed alginate, at least one plasticizer, at least one crosslinker, and at least one lubricant optionally with reinforcement fibers and one or more additives. A method of manufacturing this composition is also provided. It comprises the steps of A) mixing together the components of the composition, thus producing a mixture of powders, and B) carrying out a reactive extrusion of the mixture of powders.

### CROSS REFERENCE TO RELATED APPLICATIONS

This application claims benefit, under 35 U.S.C. § 119(e), of U.S. provisional application Ser. No. 63/770,458, filed on Mar. 12, 2025. All documents above are incorporated herein in their entirety by reference.

### FIELD OF THE INVENTION

The present invention relates to a thermoplastic water-free solvent-free bioplastic composition. More specifically, the present invention is concerned with such a composition based on seaweed alginate.

### BACKGROUND OF THE INVENTION

### On Bioplastics

Bioplastics are a category of plastics derived from renewable biomass sources, such as plants, as opposed to traditional petroleum-based plastics. These materials include bio-based plastics, which are produced from biological substances like corn starch, sugarcane, or cellulose, and biodegradable plastics, which can be decomposed by microorganisms into water, carbon dioxide, and compost under appropriate conditions. Compostable plastics, a specific type of biodegradable plastic, are designed to break down in composting environments without leaving toxic residues. Depending on the exact bioplastic, advantages may include a reduced carbon footprint compared to conventional plastics, the absence of harmful chemicals such as bisphenol A (BPA), and the utilization of renewable resources, thereby decreasing reliance on fossil fuels.

### On Industrial Plastic Processing

The are several main methods used to process plastic industrially. Injection molding is one of the most widely used methods. In this process, plastic pellets are melted and injected into a mold where they cool and solidify into the desired shape. This method is commonly used for making items like toys, automotive parts, and containers.

Blow molding is another method used to create hollow plastic products like bottles and containers. In this process, a molten plastic tube is inflated inside a mold to form the desired shape. Extrusion involves melting plastic and pushing it through a die to create long continuous shapes like pipes, straws, and window frames. The extruded plastic is then cooled and cut to the desired length.

Thermoforming involves heating a plastic sheet until it's pliable, then forming it over a mold. This method is often used for packaging, trays, and other thin-walled products. Compression molding involves placing a plastic material into a heated mold and then compressing it to form the desired shape. This method is commonly used for making large, fairly simple items like automotive parts and housings.

Rotational molding, also known as rotomolding, is used to create large, hollow objects with uniform wall thickness, such as tanks and playground equipment. In this process, the plastic is placed in a mold that is rotated and heated simultaneously. Transfer molding is similar to compression molding and involves heating the plastic to a point of plasticity before placing it into a mold. This method is typically used for thermosetting plastics.

### On Industrial Processing of Bioplastics

Using traditional plastic processing methods with bioplastics can pose several challenges due to their unique properties. One significant issue is that many bioplastics are thermosetting rather than thermoplastic. Thermosetting plastics, once cured, cannot be remelted or reshaped, which limits their use in processes like injection molding, extrusion, and thermoforming that rely on the ability to melt and reform the material. This makes it difficult to adapt these methods for bioplastics that require different handling and processing techniques.

Another challenge is the thermal stability of bioplastics. Many bioplastics decompose at relatively low temperatures compared to conventional plastics. For example, polylactic acid (PLA) and thermoplastic starch (TPS) can start to degrade at temperatures that are commonly used in industrial plastic processing. This decomposition can lead to issues such as reduced mechanical properties, discoloration, and the release of volatile compounds, making it difficult to maintain the quality and consistency of the final product.

Additionally, bioplastics often have different mechanical properties compared to traditional plastics. They can be more brittle or have lower impact resistance, which can affect their performance in applications that require durability and flexibility. This necessitates modifications in the processing equipment and conditions to accommodate these differences, which can be costly and time-consuming.

Moreover, the biodegradability of bioplastics, while environmentally beneficial, can pose challenges during processing and storage. Bioplastics can begin to degrade when exposed to moisture, heat, or microbial activity, complicating their handling and storage before and after processing. Ensuring that bioplastics remain stable until they are ready to be used in their final application requires careful control of environmental conditions.

Regarding injection molding more specifically, one significant drawback is thermal sensitivity. As noted above, many bioplastics can degrade when exposed to the temperature involved in injection molding. This can lead to issues like reduced mechanical properties, discoloration, and the release of volatile compounds, which can compromise the quality of the final product. Another challenge is the compatibility of bioplastics with existing injection molding equipment. Traditional injection molding machines are often designed for petroleum-based plastics, and using bioplastics may require modifications to the equipment or the process parameters. This can involve additional costs and time for manufacturers to adapt their processes. The flow characteristics of bioplastics can also differ significantly from conventional plastics. Variations in melt viscosity can affect the mold filling process, leading to defects such as incomplete filling, warping, or poor surface finish. This necessitates careful mold flow analysis and potentially redesigning molds to accommodate the specific properties of bioplastics. Finally, some bioplastic formulations can be more abrasive or prone to sticking, which can increase tool wear and maintenance requirements. This can result in higher operational costs and downtime for maintenance, further complicating the use of bioplastics in injection molding.

### On Single-use and Few-use Laboratory or Medical Equipment

Single-use laboratory equipment and single-use medical equipment are generally designed for one-time use to ensure sterility, prevent cross-contamination, and enhance convenience. Few-use laboratory or medical equipment can be used more than once before being discarded, but not as many times as reusable items.

Such laboratory equipment includes items like pipette tips, test tubes, and bioreactors. These are used in various scientific and biopharmaceutical processes to maintain sterility, prevent contamination between experiments, reduce cleaning time by eliminating the need for sterilization between uses, and enhance efficiency by using pre-sterilized, ready-to-use items.

Single/few-use medical equipment encompasses items such as syringes, catheters, and surgical instruments. These are used in medical settings to ensure patient safety by preventing infections and cross-contamination, maintain high hygiene standards by disposing of items after one use to avoid the risk of contamination, and reduce costs by lowering the need for sterilization and reprocessing.

The materials used in single-use laboratories and medical equipment must meet stringent criteria to ensure safety and functionality. These criteria include biocompatibility, meaning the materials must not react adversely with biological tissues or fluids; non-leaching, meaning the materials should not release harmful substances into the biological or chemical environment; chemical resistance, meaning the materials must withstand exposure to various chemicals without degrading; thermal stability, meaning the materials should resist high temperatures during processes like sterilization; and mechanical strength, meaning the materials must be durable enough to perform their intended function without failure.

### SUMMARY OF THE INVENTION

In accordance with the present invention, there is provided:
1. A thermoplastic water-free solvent-free bioplastic composition comprising:
a seaweed alginate,
at least one plasticizer, and
at least one crosslinker.
2. The composition of embodiment 1, being free of liquids.
3. The composition of embodiment 1 or 2, wherein a ratio of mannuronic acid (M) repeat units to guluronic acid (G) repeat units (M/G ratio) in the seaweed alginate is between about 0.5 and about 1.5.
4. The composition of any one of embodiments 1 to 3, wherein a molecular weight of the seaweed alginate is from about 33,000 to about 400,000 g/mol.
5. The composition of any one of embodiments 1 to 4, comprising the seaweed alginate in a concentration of at least about 10 wt/wt %, preferably at least about 15 wt/wt %, more preferably at least about 20 wt/wt %, and yet more preferably at least about 25 wt/wt %, based on the total weight of the composition.
6. The composition of any one of embodiments 1 to 5, comprising the seaweed alginate in a concentration of at most about 70 wt/wt %, preferably at most about 60 wt/wt %, more preferably at most about 50 wt/wt %, yet more preferably at most about 40 wt/wt %, and even more preferably at most about 35 wt/wt %, based on the total weight of the composition.
7. The composition of any one of embodiments 1 to 6, comprising the seaweed alginate in a concentration of about 30 wt/wt % or about 50 wt/wt %, preferably a concentration of about 30 wt/wt %, based on the total weight of the composition.
8. The composition of any one of embodiments 1 to 67, comprising the seaweed alginate in a concentration between about 25 wt/wt % and about 35 wt/wt %, preferably a concentration of about 30 wt/wt %, based on the total weight of the composition.
9. The composition of any one of embodiments 1 to 8, wherein the seaweed alginate originates from:
Macrocystis pyrifera (Giant Kelp)
Ascophyllum nodosum,
Laminaria hyperborea,
Laminaria digitata,
Ecklonia maxima,
Lessonia nigrescens,
Sargassum spp.,
Durvillaea antarctica,
Turbinaria triquetra,
Padina boergesenii,
Hormophysa cuneiformis, and/or
Dictyota ciliolate.
10. The composition of any one of embodiments 1 to 9, wherein the plasticizer is glycerol, diglycerol, glycerol monoacetate, glycerol diacetate, sorbitol, sorbitan, mannitol, 1,3-propanediol, 1,2,3-hexanetriol, butanediol, butanetriol, ethylene glycol, polyethylene glycol (PEG), propylene glycol, polybutylene adipate-co-terephthalate (PBAT), polybutylene succinate (PBS), polycaprolactone (PCL), polybutylene succinate adipate (PBSA), Polyhydroxyalkanoates (PHA), 1,3-trimethylene glycol, triethyl citrate, urea, polylactic acid (PLA), microcrystalline cellulose, seaweed nano cellulose, rice husk powder, acacia gum, algae oil, coconut oil, an ester gum, palm stearin, or a thermoplastic cellulose ether, or a mixture thereof.
11. The composition of any one of embodiments 1 to 10, wherein the plasticizer is PLA or PEG (preferably PLA) or a mixture of A) PEG or PLA (preferably PLA) with B) triethyl citrate or glycerol (preferably triethyl citrate).
12. The composition of any one of embodiments 1 to 11, wherein the plasticizer is a mixture of PLA with triethyl citrate.
13. The composition of any one of embodiments 1 to 12, wherein the mixture of PLA with triethyl citrate (TC) has a PLA: TC weight ratio of about 2:1 to about 4:1, preferably about 3:1.
14. The composition of any one of embodiments 1 to 11, wherein the plasticizer is PLA.
15. The composition of any one of embodiments 1 to 14, comprising the plasticizer in a concentration of at least about 5 wt/wt %, preferably at least about 10 wt/wt %, more preferably at least about 15 wt/wt %, yet more preferably at least about 20 wt/wt %, even more preferably at least about 25 wt/wt %, more preferably at least about 30 wt/wt %, yet more preferably at least about 35 wt/wt %, and most preferably at least about 40 wt/wt %, based on the weight of the composition.
16. The composition of any one of embodiments 1 to 15, comprising the plasticizer in a concentration of at most about 50 wt/wt %, preferably at most about 45 wt/wt %, more preferably at most about 40 wt/wt %, based on the weight of the composition.
17. The composition of any one of embodiments 1 to 16, comprising the plasticizer in a concentration of about 30 wt/wt % or about 40 wt/wt %, preferably about 40 wt/wt %, based on the weight of the composition.
18. The composition of any one of embodiments 1 to 16, comprising the plasticizer in a concentration between about 35 wt/wt % and about 45 wt/wt %, preferably a concentration of about 40 wt/wt %, based on the weight of the composition.
19. The composition of any one of embodiments 1 to 18, wherein the crosslinker is a metal salt or a metal salt hydrate, or a mixture thereof; preferably a metal chloride, a metal carbonate salt, a metal nitrate salt, a metal lactate salt, a metal oxalate salt, a metal acetate salt, an hydrate of these salts, or a mixture thereof; more preferably CaCl₂, CaCl₂·2H₂O, Ca(NO₃)₂·4H₂O, CaSO₄·2H₂O, AlK(SO₄)₂·12H₂O, or a mixture thereof; preferably CaCl₂ or calcium acetate, and most preferably calcium acetate; or alternatively preferably CaCl₂.
20. The composition of any one of embodiments 1 to 19, comprising the crosslinker in a concentration of at least about 2 wt/wt %, preferably at least about 5 wt/wt %, more preferably at least about 10 wt/wt %, yet more preferably at least about 12.5 wt/wt %, and most preferably at least about 15 wt/wt %, based on the total weight of the composition.
21. The composition of any one of embodiments 1 to 20, comprising the crosslinker in a concentration of at most about 20 wt/wt %, preferably at most about 17.5 wt/wt %, and more preferably at most about 15 wt/wt %, based on the total weight of the composition.
22. The composition of any one of embodiments 1 to 21, comprising the crosslinker in a concentration of about 5 wt/wt % or about 15 wt/wt %, preferably 15 wt/wt %, based on the total weight of the composition.
23. The composition of any one of embodiments 1 to 21, comprising the crosslinker in a concentration between about 12.5 wt/wt % and about 17.5 wt/wt %, preferably a concentration of about 15 wt/wt %, based on the weight of the composition.
24. The composition of any one of embodiments 1 to 23, further comprising one or more lubricants.
25. The composition of embodiment 24, wherein the lubricant is an oil (such as epoxidized soyabean oil), a fatty acid (such as stearic acid), a wax, PEG (which also acts as a plasticizer), or a mixture thereof; preferably stearic acid.
26. The composition embodiment 25 or 25, comprising the lubricant in a concentration between about 1 wt/wt % and about 5 wt/wt %, preferably in a concentration of about 5 wt/wt %, based on the total weight of the composition.
27. The composition of any one of embodiments 1 to 23, being free of lubricants.
28. The composition of any one of embodiments 1 to 27, further comprising a reinforcement fiber; preferably natural fibers, more preferably cellulosic fibers, yet more preferably hemp fibers, jute fibers, sisal fibers, citrus fibers, flax fibers, bamboo fibers, or a mixture thereof, even more preferably hemp fibers or flax fibers, and most preferably hemp fibers.
29. The composition of embodiment 28, comprising the reinforcement fiber in a concentration of at least about 2.5 wt/wt %, preferably at least about 5 wt/wt %, based on the total weight of the composition.
30. The composition of embodiment 28 or 29, comprising the reinforcement fiber in a concentration of at most about 20 wt/wt %, preferably at most about 15 wt/wt %, more preferably at most about 10 wt/wt %, yet more preferably at most about 7.5 wt/wt %, and most preferably at most about 5 wt/wt %, based on the total weight of the composition.
31. The composition of any one of embodiments 28 to 30, comprising the reinforcement fiber in a concentration of about 5 wt/wt % or about 10 wt/wt %, preferably 5 wt/wt %, based on the total weight of the composition.
32. The composition of any one of embodiments 28 to 30, comprising the reinforcement fiber in a concentration between about 2.5 wt/wt % and about 7.5 wt/wt %, preferably a concentration of about 5 wt/wt %, based on the weight of the composition.
33. The composition of any one of embodiments 1 to 32, further comprising one or more additives.
34. The composition of embodiment 33, wherein the one or more additives is starch, preferably thermoplastic starch, microcrystalline cellulose (MCC), guar gum, carboxymethyl cellulose (CMC), a mineral salt, calcium carbonate, calcium carbonate hydrate, or a mixture thereof.
35. The composition of embodiment 33 or 34, wherein the one or more additives is starch, preferably thermoplastic starch.
36. The composition of any one of embodiments 33 to 35, comprising said one or more additives in a total concentration of at most about 20 wt/wt %, preferably at most about 15 wt/wt %, more preferably at most about 12.5 wt/wt %, and yet more preferably at most about 10 wt/wt %, based on the total weight of the composition.
37. The composition of any one of embodiments 33 to 36, comprising said one or more additives in a total concentration of at least about 2.5 wt/wt %, preferably at least about 5 wt/wt %, more preferably at least about 7.5 wt/wt %, and yet more preferably at least about 10 wt/wt %, based on the total weight of the composition.
38. The composition of any one of embodiments 33 to 37, comprising said one or more additives in a total concentration between about 7.5 wt/wt % and about 12.5 wt/wt %, preferably at a concentration of about 10 wt/wt %, based on the total weight of the composition.
39. The composition of any one of embodiments 1 to 32, being free of microcrystalline cellulose (MCC), guar gum, carboxymethyl cellulose (CMC), a mineral salt, calcium carbonate, calcium carbonate hydrate, or a mixture thereof
40. The composition of any one of embodiments 1 to 32, being free of additives.
41. The composition of any one of embodiments 1 to 41, wherein the composition of the invention is free of one or more, preferably all of the following:
soy protein isolate, more generally any plant proteins, and yet more generally any protein,
a starch
seaweed nanocellulose, and/or
a cellulose ether linked to the seaweed alginate or another cellulose ether.
42. The composition of any one of embodiments 1 to 41, comprising:
seaweed alginate; preferably present at a concentration between about 30 wt/wt % and about 50 wt/wt %, more preferably between about 25 wt/wt % and about 35 wt/wt %, and most preferably a concentration of about 30 wt/wt %,
as plasticizers:
   PLA, preferably present at a concentration of about 30 wt/wt %, or
   preferably a mixture of PLA and triethyl citrate, preferably in a 3:1 PLA: TC weight ratio; preferably in a total concentration between about 35 wt/wt % and about 45 wt/wt %, preferably at a concentration of about 40 wt/wt %,
as the crosslinker: calcium chloride or calcium acetate, preferably calcium acetate, preferably at a concentration between about 5 wt/wt % and about 15 wt/wt %, preferably at a concentration between about 12.5 wt/wt % and about 17.5 wt/wt %, more preferably at a concentration of about 15 wt/wt %,
hemp fibers as reinforcement fibers, preferably at a concentration between about 5 wt/wt % and about 10 wt/wt %, or at a concentration between about 2.5 wt/wt % and about 7.5 wt/wt %, more preferably at a concentration of about 5 wt/wt %,
either stearic acid as a lubricant (preferably at a concentration between about 2.5 wt/wt % and about 7.5 wt/wt %, more preferably at a concentration of about 5 wt/wt %) and/or thermoplastic starch as an additive (preferably at a concentration between about 7.5 wt/wt % and about 12.5 wt/wt %, more preferably a concentration of about 10 wt/wt %),
all percentages being based on the total weight of the composition.
43. The composition of any one of embodiments 1 to 42, comprising:
seaweed alginate; preferably at a concentration between about 25 wt/wt % and about 35 wt/wt %, preferably at a concentration of about 30 wt/wt %,
as plasticizers a mixture of PLA and triethyl citrate, preferably in a 3:1 PLA: TC weight ratio; preferably in a total concentration between about 35 wt/wt % and about 45 wt/wt %, preferably of about 40 wt/wt %,
as the crosslinker: calcium acetate, preferably at a concentration between about 12.5 wt/wt % and about 17.5 wt/wt %, and more preferably at a concentration of about 15 wt/wt %,
hemp fibers as reinforcement fibers, preferably in a concentration between about 2.5 wt/wt % and about 7.5 wt/wt %, more preferably at a concentration of about 5 wt/wt %,
thermoplastic starch as an additive, preferably at a concentration between about 7.5 wt/wt % and about 12.5 wt/wt %, and more preferably a concentration of about 10 wt/wt %,
all percentages being based on the total weight of the composition.
44. The composition of any one of embodiments 1 to 43, being in solid form.
45. The composition of any one of embodiments 1 to 44, being in the form of pellets.
46. The composition of any one of embodiments 1 to 44, being in the form of a wire, for example, an extruded wire.
47. The composition of any one of embodiments 1 to 46, for use in injection molding, blow molding, extrusion, thermoforming, compression molding, rotational molding (rotomolding), or transfer molding.
48. The composition of any one of embodiments 1 to 47, being heat-resistant.
49. The composition of any one of embodiments 1 to 48, being thermostable up to about 120° C., preferably up to about 140° C., and most preferably up to about 160° C.
50. The composition of any one of embodiments 1 to 49, for use in manufacturing single-use or few-use plastic items, preferably laboratory equipment or medical equipment.
51. The composition of embodiment 50, wherein the single-use and few-use laboratory equipment comprises pipettes and pipette tips, test tubes, Falcon tubes, centrifuge and microcentrifuge tubes, tubing, weigh boats, and cuvettes.
52. The composition of embodiment 51, wherein the single-use and few-use in medical equipment comprises syringes, pipettes, test tubes, centrifuge tubes, measuring cylinders, funnels, microcentrifuge tubes, plastic droppers, storage bottles, filter bottles, Falcon tubes, weigh boats, and cuvettes.
53. The composition of any one of embodiments 1 to 52, having a tensile strength from about 20 MPa to about 150 MPa.
54. The composition of any one of embodiments 1 to 53, having a Young's modulus from about 50 MPa to 200 about MPa.
55. A method of manufacturing the composition of any one of embodiments 1 to 54, the method comprising the steps of:
A) mixing together:
   the seaweed alginate,
   the at least one plasticizer,
   the at least one crosslinker,
   optionally, the at least one lubricant,
   optionally, the reinforcement fiber, and
   optionally, the one or more additives,
   thus producing a mixture of powders, and
B) carrying out a reactive extrusion of the mixture of powders.
56. The method of embodiment 55, being carried out in the absence of water.
57. The method of embodiment 55 or 56, being carried out in the absence of a solvent.
58. The method of any one of embodiments 55 to 57, being carried out in the absence of liquids.
59. The method of any one of embodiments 1 to 58, wherein the extrusion at step B) is carried out in a twin-screw extruder.
60. The method of embodiment 59, wherein the temperature of the extruder barrel is between about 160 about 180° C.
61. The method of embodiment 59 or 90, wherein the screw Speed is between about 40 and about 100 RPM, between about 80 and about 100 RPM.
62. The method of any one of embodiments 59 to 61, wherein the die temperature is between about 165° C.
63. The method of any one of embodiments 55 to 62, wherein after extrusion, the composition is cooled, preferably in air or in a water bath.
64. The method of any one of embodiments 55 to 63, wherein the mixture of powder is extruded in the form of pellets.
65. The method of any one of embodiments 55 to 63, wherein the mixture of powder is extruded in the form of a wire.
66. The method of any one of embodiments 55 to 65, further comprising, before step A), the step of extracting the seaweed alginate from seaweed, preferably from brown seaweed, more preferably from one or more of the following species of brown seaweed:
Macrocystis pyrifera (Giant Kelp)
Ascophyllum nodosum,
Laminaria hyperborea,
Laminaria digitata,
Ecklonia maxima,
Lessonia nigrescens,
Sargassum spp.,
Durvillaea antarctica,
Turbinaria triquetra,
Padina boergesenii,
Hormophysa cuneiformis, and
Dictyota ciliolate.
67. The method of embodiment 66, wherein the seaweed alginate is extracted from the brown seaweed using an acid treatment, typically using HCl, to convert alginic acid salts into alginic acid, followed by extraction of the alginic acid by treating the seaweed with an alkaline aqueous solution, typically sodium carbonate (Na₂CO₃) or sodium hydroxide (NaOH), to convert the alginic acid into water-soluble sodium alginate.
68. The method of embodiment 66 or 67, wherein the extraction is assisted using one or more of an enzymatic treatment, ultrasound, microwave, or reactive extrusion
69. The method of embodiment 68, wherein the extraction is assisted using ultrasound and/or microwave, preferably both.
70. The method of embodiment 68 or 69, wherein the extraction assisted by microwave is carried out by treating seaweed in a microwave reactor with an alkaline solvent; preferably, microwave energy is applied at a controlled power and temperature (for examples about 70 to about 90° C.); preferably, the reaction mixture is stirred continuously to ensure even heating.
71. The method of any one of embodiments 68 to 70, wherein the extraction assisted by sonication is carried out by soaking seaweed powder in an alkaline solution, and then, applying ultrasound (for example, at 20-40 kHz, 100-500 W, at 50-70° C. for 30-60 minutes); preferably, the reaction mixture is continuously stirred.
72. The method of any one of embodiments 55 to 71, further comprising the step of, after extraction, filtering out solid residues.
73. The method of any one of embodiments 55 to 72, further comprising the step of using CaCl₂ or ethanol to neutralize and precipitate the seaweed alginate.
74. The method any one of embodiments 55 to 73, further comprising the step of washing, drying, and grinding the seaweed alginate.

### BRIEF DESCRIPTION OF THE DRAWINGS

In the appended drawings:

FIG. 1 shows pictures of the dog bone shape samples used in Example 1 A) before and B) after testing.

FIG. 2 shows the Thermogravimetric Analysis of the bioplastic of Example 1.

FIG. 3 shows the Differential Scanning Calorimetry of the bioplastic of Example 1.

FIG. 4 shows failed compression molding of the bioplastic of Comparative Example 1.

FIG. 5 shows pictures of the dog bone shape samples used in Example 2 after testing

### DETAILED DESCRIPTION OF THE INVENTION

Turning now to the invention in more details, there is provided a thermoplastic water-free solvent-free bioplastic composition comprising:
a seaweed alginate,
at least one plasticizer, and
at least one crosslinker.

The composition of the invention is in solid form. It can be provided e.g., in pellets or in the form of a wire.

The composition of the invention is compatible with current plastic manufacturing technologies, particularly when it is in the form of pellets. For example, the composition of the invention can be used in injection molding. This injection molding can be carried out in the same way as when using conventional thermoplastic pellets.

Further, the composition of the invention can resist heat. For example, the composition of the invention resists heating at, for example, 120° C. for injection molding. In fact, it is thermostable up to 140° C. and even up to 160° C., which is suitable e.g., for autoclaving in laboratories and medical facilities.

The composition of the invention can be used to manufacture single-use or few-use plastic items, particularly as laboratory equipment or as medical equipment.

Non-limiting examples of single-use and few-use plastic items commonly used in laboratory settings include pipettes and pipette tips, test tubes, Falcon tubes, centrifuge and microcentrifuge tubes, tubing, weigh boats, and cuvettes.

Non-limiting examples of single-use and few-use plastic items commonly used in medical equipment include syringes, pipettes, test tubes, centrifuge tubes, measuring cylinders, funnels, microcentrifuge tubes, plastic droppers, storage bottles, filter bottles, Falcon tubes, weigh boats, and cuvettes.

The composition of the invention exhibits a tensile strength of about 20 MPa to about 150 MPa. The Young's modulus can vary from about 50 MPa to 200 about MPa.

As well known in the art, a “thermoplastic” is a polymer material that melts and/or becomes pliable or moldable when heated and solidifies upon cooling. Thermoplastics can generally undergo multiple cycles of melting and solidifying without significant chemical change, allowing them to be reshaped and recycled. In contrast, a thermoset is a polymer material that, once cured or hardened through a chemical reaction, becomes permanently set. Thermosets are characterized by significant cross-linking between polymer chains, which creates a rigid, infusible, and insoluble structure. Upon heating, thermosets do not melt but rather decompose.

Herein, the term “water-free” means that the composition is free of water.

Herein, the term “solvent-free” means that the composition is free of solvent. Herein, a solvent is a liquid that has the ability to dissolve, suspend, or extract other the composition of the invention or a component thereof. Non-limiting examples of solvents include:
hydrocarbon solvents, including aliphatic hydrocarbons e.g., hexane and heptane; and aromatic hydrocarbons e.g., toluene and xylene,
oxygenated solvents including alcohols, e.g., methanol and ethanol; ketones e.g., acetone and methyl ethyl ketone (MEK); esters e.g., ethyl acetate and butyl acetate; and ethers e.g., tetrahydrofuran (THF) and diethyl ether,
chlorinated solvents e.g., dichloromethane (methylene chloride) and chloroform;
amides e.g., n, n-dimethylformamide (DMF) and n-methyl-2-pyrrolidone (NMP); and
nitro hydrocarbons e.g., nitromethane.

In embodiments, the composition of the invention is free of liquids.

Herein, “free of” water, solvent, or liquids means free of added water, solvent, or liquids. For example, “free of” water, solvent, or liquids includes the fact that the bioplastic composition of the invention is free of water, solvent, or liquids introduced during the manufacture of the composition from its constituents: the seaweed alginate, the at least one plasticizer, the at least one crosslinker, optionally a lubricant, optionally reinforcement fibers, and optionally one or more additives. In fact, the bioplastic composition of the invention is preferably manufactured from its constituents in absence of water, solvent, or liquids. As such, the bioplastic composition of the invention is inevitably free of water, solvent, or liquids used for such purposes.

Herein, the term “bioplastic” means a plastic derived from renewable biological sources, such as seaweed alginate and kappa carrageenan, preferably seaweed alginate.

As is well known in the art, “seaweed alginate” is a polysaccharide found in the cell walls of brown algae (seaweed). It is composed of two types of repeat units: mannuronic acid (M) and guluronic acid (G). The ratio and sequence of these monomers determine the properties of the alginate. The ratio of mannuronic acid (M) repeat units to guluronic acid (G) repeat units (M/G ratio) of seaweed alginate typically varies between about 0.5 and about 1.5. Typically, the molecular weight of seaweed alginate ranges from about 33,000 to about 400,000 g/mol.

In embodiments, the composition of the invention comprises the seaweed alginate in a concentration of at least about 10 wt/wt %, preferably at least about 15 wt/wt %, more preferably at least about 20 wt/wt %, and yet more preferably at least about 25 wt/wt %, based on the total weight of the composition.

In embodiments, the composition of the invention comprises the seaweed alginate in a concentration of at most about 70 wt/wt %, preferably at most about 60 wt/wt %, more preferably at most about 50 wt/wt %, yet more preferably at most about 40 wt/wt %, and even more preferably at most about 35 wt/wt %, based on the total weight of the composition.

In most preferred embodiments, the composition of the invention comprises the seaweed alginate in a concentration of about 30 wt/wt % or about 50 wt/wt %, preferably a concentration of about 30 wt/wt %, based on the total weight of the composition. In most preferred embodiments, the composition of the invention comprises the seaweed alginate in a concentration between about 25 wt/wt % and about 35 wt/wt %, preferably a concentration of about 30 wt/wt %, based on the total weight of the composition.

Sources of seaweed alginate include various brown seaweed species. In embodiments, the seaweed alginate originates from:
Macrocystis pyrifera (Giant Kelp)
Ascophyllum nodosum,
Laminaria hyperborea,
Laminaria digitata,
Ecklonia maxima,
Lessonia nigrescens,
Sargassum spp.,
Durvillaea antarctica,
Turbinaria triquetra,
Padina boergesenii,
Hormophysa cuneiformis, and
Dictyota ciliolate.

As well know in the art, a “plasticizer” is an agent added to polymeric composition to enhance their flexibility, workability, and overall mechanical properties. In embodiments, the plasticizer is glycerol, diglycerol, glycerol monoacetate, glycerol diacetate, sorbitol, sorbitan, mannitol, 1,3-propanediol, 1,2,3-hexanetriol, butanediol, butanetriol, ethylene glycol, polyethylene glycol (PEG), propylene glycol, polybutylene adipate-co-terephthalate (PBAT), polybutylene succinate (PBS), polycaprolactone (PCL), polybutylene succinate adipate (PBSA), Polyhydroxyalkanoates (PHA), 1,3-trimethylene glycol, triethyl citrate, urea, polylactic acid (PLA), microcrystalline cellulose, seaweed nano cellulose, rice husk powder, acacia gum, algae oil, coconut oil, an ester gum, palm stearin, or a thermoplastic cellulose ether, or a mixture thereof.

In preferred embodiments, the plasticizer is PLA or PEG (preferably PLA) or a mixture of A) PEG or PLA (preferably PLA) with B) triethyl citrate or glycerol (preferably triethyl citrate). In more preferred embodiments, the plasticizer is a mixture of PLA with triethyl citrate. Alternatively, the plasticizer is PLA. In preferred embodiments, the mixture of PLA with triethyl citrate (TC) has a PLA: TC weight ratio of about 2:1 to about 4:1, preferably about 3:1.

In embodiments, the composition of the invention comprises the plasticizer in a concentration at least about 5 wt/wt %, preferably at least about 10 wt/wt %, more preferably at least about 15 wt/wt %, yet more preferably at least about 20 wt/wt %, even more preferably at least about 25 wt/wt %, more preferably at least about 30 wt/wt %, yet more preferably at least about 35 wt/wt %, and most preferably at least about 40 wt/wt %, based on the weight of the composition.

In embodiments, the composition of the invention comprises the plasticizer in a concentration between at most about 50 wt/wt %, preferably at most about 45 wt/wt %, more preferably at most about 40 wt/wt %, based on the weight of the composition.

In most preferred embodiments, the composition of the invention comprises the plasticizer in a concentration of about 30 wt/wt % or about 40 wt/wt %, preferably about 40 wt/wt %, based on the weight of the composition. In most preferred embodiments, the composition of the invention comprises the plasticizer in a concentration between about 35 wt/wt % and about 45 wt/wt %, preferably a concentration of about 40 wt/wt %, based on the weight of the composition.

As well known in the art, “crosslinkers” can be used to produce thermoplastic, in which they create covalent bonds between polymer chains, resulting in a network structure that enhances the mechanical strength, elasticity, and durability of the material. In embodiments, the crosslinker is a metal salt or a metal salt hydrate, or a mixture thereof. Non-limiting examples of metal salts or metal salt hydrates include metal chlorides, carbonates, nitrates, lactates, oxalates, acetate salts, as well as their hydrates, and mixtures thereof. In preferred embodiments, the crosslinker is CaCl₂, CaCl₂·2H₂O, Ca(NO₃)₂·4H₂O, CaSO₄·2H₂O, AlK(SO₄)₂·12H₂O. In most preferred embodiments, the crosslinker is CaCl₂ or calcium acetate, preferably calcium acetate; or alternatively preferably CaCl₂.

In embodiments, the composition of the invention comprises the crosslinker in a concentration of at least about 2 wt/wt %, preferably at least about 5 wt/wt %, more preferably at least about 10 wt/wt %, yet more preferably at least about 12.5 wt/wt %, and most preferably at least about 15 wt/wt %, based on the total weight of the composition.

In embodiments, the composition of the invention comprises the crosslinker in a concentration of at most about 20 wt/wt %, preferably at most about 17.5 wt/wt %, and more preferably at most about 15 wt/wt %, based on the total weight of the composition.

In embodiments, the composition of the invention comprises the crosslinker in a concentration of about 5 wt/wt % or about 15 wt/wt %, preferably 15 wt/wt %, based on the total weight of the composition. In most preferred embodiments, the composition of the invention comprises the crosslinker in a concentration between about 12.5 wt/wt % and about 17.5 wt/wt %, preferably a concentration of about 15 wt/wt %, based on the weight of the composition.

In embodiments, the composition of the invention further comprises the lubricant. As well known in the art, a “lubricant” is an additive used to reduce friction during the processing and molding of bioplastic materials. In embodiments, the lubricant is an oil (such as epoxidized soyabean oil), a fatty acid (such as stearic acid), a wax, PEG (which also acts as a plasticizer), or a mixture thereof. In preferred embodiments, the crosslinker is stearic acid.

In embodiments, the composition of the invention comprises the lubricant in a concentration between about 1 wt/wt % and about 5 wt/wt %, preferably in a concentration of about 5 wt/wt %, based on the total weight of the composition.

In alternative embodiments, the composition of the invention is free from a lubricant.

In embodiments, the composition of the invention further comprises a reinforcement fiber. As well know in the art, a “reinforcement fiber” is a fibrous material used to enhance mechanical properties, such as strength, stiffness, and durability. In embodiments, the reinforcement fiber is natural fibers, preferably cellulosic fibers, more preferably hemp fibers, jute fibers, sisal fibers, citrus fibers, flax fibers, bamboo fibers, or a mixture thereof. In preferred embodiments, the reinforcement fiber is hemp fibers or flax fibers, preferably hemp fibers.

In embodiments, the composition of the invention comprises the reinforcement fiber in a concentration of at least about 2.5 wt/wt %, preferably at least about 5 wt/wt %, based on the total weight of the composition.

In embodiments, the composition of the invention comprises the reinforcement fiber in a concentration of at most about 20 wt/wt %, preferably at most about 15 wt/wt %, more preferably at most about 10 wt/wt %, yet more preferably at most about 7.5 wt/wt %, and most preferably at most about 5 wt/wt %, based on the total weight of the composition.

In embodiments, the composition of the invention comprises the reinforcement fiber in a concentration of about 5 wt/wt % or about 10 wt/wt %, preferably 5 wt/wt %, based on the total weight of the composition. In most preferred embodiments, the composition of the invention comprises the reinforcement fiber in a concentration between about 2.5 wt/wt % and about 7.5 wt/wt %, preferably a concentration of about 5 wt/wt %, based on the weight of the composition.

In embodiments, the composition of the invention further comprises one or more additives. In embodiments, the one or more additives is:
Starch, preferably thermoplastic starch, which acts as a reinforcing agent.
Microcrystalline Cellulose (MCC), which acts as a reinforcing agent, enhancing mechanical strength, thermal stability, and overall durability of the bioplastic. MCC can also improves the barrier properties against gases and moisture.
Guar Gum, which acts as a thickening and stabilizing agent. It improves the flexibility and film-forming properties of the bioplastic, and can also enhance its biodegradability.
Carboxymethyl Cellulose (CMC), which improves the mechanical properties and water resistance of bioplastics. It acts as a binder, helping to form a uniform and stable bioplastic film, and enhances biodegradability.
Mineral Salt, which enhance the thermal stability and mechanical properties of bioplastics. They can act as nucleating agents, promoting crystallization of the bioplastic matrix, which improves strength and durability.
Calcium Carbonate, which acts as a filler that improves mechanical properties such as tensile strength and rigidity and reduces production costs. It also enhances biodegradability.
Calcium Carbonate Hydrate, which can influence the mechanical properties and biodegradability of bioplastics. It helps in maintaining flexibility and stability under different environmental conditions or a mixture thereof. In preferred embodiments, the one or more additives is thermoplastic starch.

In embodiments, the composition of the invention is free of the above additives.

In embodiments, the composition of the invention comprises said one or more additives in a total concentration of at most about 20 wt/wt %, preferably at most about 15 wt/wt %, more preferably at most about 12.5 wt/wt %, and yet more preferably at most about 10 wt/wt %, based on the total weight of the composition.

In embodiments, the composition of the invention comprises said one or more additives in a total concentration at least about 2.5 wt/wt %, preferably at least about 5 wt/wt %, more preferably at least about 7.5 wt/wt %, and yet more preferably at least about 10 wt/wt %, based on the total weight of the composition.

In embodiments, the composition of the invention comprises said one or more additives in a total concentration between about 7.5 wt/wt % and about 12.5 wt/wt %, preferably at a concentration of about 10 wt/wt %, based on the total weight of the composition.

In embodiments, the composition of the invention is free of one or more, preferably all of the following:
soy protein isolate, more generally any plant proteins, and yet more generally any protein,
seaweed nanocellulose, and/or
a cellulose ether linked to the seaweed alginate, or another cellulose ether.

In embodiments, the composition of the invention is free of starches.

In embodiments, the composition of the invention is in the form of pellets.

In embodiments, the composition of the invention is in the form of a wire, for example, an extruded wire.

In embodiments, the composition of the invention comprises:
seaweed alginate; preferably present at a concentration between about 30 wt/wt % and about 50 wt/wt %, more preferably between about 25 wt/wt % and about 35 wt/wt %, and most preferably a concentration of about 30 wt/wt %,
as plasticizers:
   PLA, preferably present at a concentration of about 30 wt/wt %, or
   preferably a mixture of PLA and triethyl citrate, preferably in a 3:1 PLA: TC weight ratio; preferably in a total concentration between about 35 wt/wt % and about 45 wt/wt %, preferably at a concentration of about 40 wt/wt %,
as the crosslinker: calcium chloride or calcium acetate, preferably calcium acetate, preferably at a concentration between about 5 wt/wt % and about 15 wt/wt %, preferably at a concentration between about 12.5 wt/wt % and about 17.5 wt/wt %, more preferably at a concentration of about 15 wt/wt %,
hemp fibers as reinforcement fibers, preferably at a concentration between about 5 wt/wt % and about 10 wt/wt %, or at a concentration between about 2.5 wt/wt % and about 7.5 wt/wt %, more preferably at a concentration of about 5 wt/wt %,
either stearic acid as a lubricant (preferably at a concentration between about 2.5 wt/wt % and about 7.5 wt/wt %, more preferably at a concentration of about 5 wt/wt %) and/or thermoplastic starch as an additive (preferably at a concentration between about 7.5 wt/wt % and about 12.5 wt/wt %, more preferably a concentration of about 10 wt/wt %), all percentages being based on the total weight of the composition.

In embodiments, the composition of the invention comprises:
seaweed alginate; preferably at a concentration between about 25 wt/wt % and about 35 wt/wt %, preferably at a concentration of about 30 wt/wt %,
as plasticizers a mixture of PLA and triethyl citrate, preferably in a 3:1 PLA: TC weight ratio; preferably in a total concentration between about 35 wt/wt % and about 45 wt/wt %, preferably of about 40 wt/wt %,
as the crosslinker: calcium acetate, preferably at a concentration between about 12.5 wt/wt % and about 17.5 wt/wt %, and more preferably at a concentration of about 15 wt/wt %,
hemp fibers as reinforcement fibers, preferably in a concentration between about 2.5 wt/wt % and about 7.5 wt/wt %, more preferably at a concentration of about 5 wt/wt %,
thermoplastic starch as an additive, preferably at a concentration between about 7.5 wt/wt % and about 12.5 wt/wt %, and more preferably a concentration of about 10 wt/wt %,
all percentages being based on the total weight of the composition.

### Method of Making the Composition of the Invention

In a related aspect, there is also provided a method of manufacturing the composition of the invention, the method comprising the steps of:
A) mixing together:
   the seaweed alginate,
   the at least one plasticizer,
   the at least one crosslinker,
   optionally, the at least one lubricant,
   optionally, the reinforcement fiber, and
   optionally, the one or more additives,
thus producing a mixture of powders, and
B) carrying out a reactive extrusion of the mixture of powders.

The seaweed alginate, the at least one plasticizer, the at least one crosslinker, the at least one lubricant, the reinforcement fiber, and the one or more additives are all as described above. They are also provided in the concentrations given above.

As is well known in the art, reactive extrusion allows is a manufacturing process that combines chemical reactions with extrusion to create new materials. It's a continuous process that can be performed in a twin screw extruder. In the method of the invention, the reactive extrusion at step B) is such that the thermoplastic water-free solvent-free bioplastic composition is obtained.

It should be noted that the method of manufacturing of the invention does not require water or a solvent, or, in fact, any liquid. In embodiments, the method of the invention is carried out in the absence of water. In embodiments, the method of the invention is carried out in the absence of a solvent. In embodiments, the method of the invention is carried out in the absence of liquids.

In embodiments, the extrusion at step B) is carried out in a twin-screw extruder.

In embodiments, the temperature of the extruder barrel is between about 160 about 180° C.

In embodiments, the screw speed is between about 40 and about 100 RPM, between about 80 and about 100 RPM.

In embodiments, the die temperature is between about 165° C.

In embodiments, after extrusion, the composition of the invention is cooled either in air (which can provide better crystallization) or in a water bath (e.g., at a temperature of 20-30° C.).

In embodiments, the mixture of powder is extruded in the form of pellets.

In embodiments, the mixture of powder is extruded in the form of a wire.

In embodiments, the method further comprises, before step A), the step of extracting the seaweed alginate from seaweed.

In embodiments, the seaweed alginate is extracted from brown seaweed, more preferably one or more of the following species of brown seaweed:
Macrocystis pyrifera (Giant Kelp)
Ascophyllum nodosum,
Laminaria hyperborea,
Laminaria digitata,
Ecklonia maxima,
Lessonia nigrescens,
Sargassum spp.,
Durvillaea antarctica,
Turbinaria triquetra,
Padina boergesenii,
Hormophysa cuneiformis, and
Dictyota Ciliolate.

The seaweed alginate can be extracted from the brown seaweed using various methods. In embodiments, the seaweed alginate is extracted using an acid treatment, typically using HCl, to convert alginic acid salts into alginic acid, followed by extraction of the alginic acid by treating the seaweed with an alkaline aqueous solution, typically sodium carbonate (Na₂CO₃) or sodium hydroxide (NaOH), to convert the alginic acid into water-soluble sodium alginate.

In embodiments, the extraction is assisted using one or more of the following:
an enzymatic treatment in which enzymes, such as cellulases, proteases, and carbohydrases, are used to break down the seaweed cell walls, facilitating the release of alginate without the need for harsh acids;
ultrasound, which disrupt the seaweed cell structure, enhancing the extraction efficiency of alginate;
microwave, which heat the seaweed, improving the extraction yield and reducing the need for acid treatments;
reactive extrusion in which the seaweed is mechanically processed, which can reduce the time, water, and reactant requirements compared to traditional alkaline extraction.

In preferred embodiments, the extraction is assisted using ultrasound and/or microwave, preferably both.

In embodiments, the extraction assisted by microwave is carried out by treating seaweed in a microwave reactor with an alkaline solvent. Preferably, microwave energy is applied at a controlled power and temperature (for examples about 70 to about 90° C.). Preferably, the reaction mixture is stirred continuously to ensure even heating. After e.g., 30 min, the reaction is typically finished.

In embodiments, the extraction assisted by sonication is carried out by soaking seaweed powder in an alkaline solution. Then, an ultrasound is applied. For example, at 20-40 kHz, 100-500 W, at 50-70° C. for 30-60 minutes. Preferably, the reaction mixture is continuously stirred.

After extraction, any solid residues can be filtered out. Finally, CaCl₂ or ethanol can be used to neutralize and precipitate the seaweed alginate. Then, the extracted alginate can be washed, dried, and ground.

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted. In contrast, the phrase “consisting of” excludes any unspecified element, step, ingredient, or the like. The phrase “consisting essentially of” limits the scope to the specified materials or steps and those that do not materially affect the basic and novel characteristic(s) of the invention.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENTS

The present invention is illustrated in further details by the following non-limiting examples.

### Example 1

### Materials and Methods

Seaweed alginate was extracted in-house by acid treatment from the brown seaweed. Once extracted, the seaweed alginate was weighed, it was dried at 40° C. in a dryer to reduce the moisture content. For the extrusion, a mixture was prepared by mixing together:
seaweed alginate—50%,
PLA (plasticizer)—30%,
hemp fiber (to improve mechanical properties)—10%,
calcium chloride (crosslinker)—5%, and
stearic acid (lubricant)—5%. All percentages being wt/wt %, based on the total weight of the formulation.

These ingredients were mixed together and dried in an oven for 5-6 hours at 50° C. The mixture was added in a twin-screw extruder with extruder screw speed of 50, 75 and 90. C. The barrel temperature profile was die 165° C., Zone 2 170° C., Zone 3 165° C., Zone 4 170° C., Zone 5 180° C., Zone 6 175° C., Zone 7 165° C., and Zone 8 165° C.

The resulting bioplastic was compression molded for testing.

### Results

The Young's modulus was estimated to be 0.054 GPa (54.87 MPa), indicating a relatively soft material with moderate stiffness. The material exhibited a yield strength of 4.5 MPa at a strain of 0.164%, marking the transition from elastic to plastic deformation.

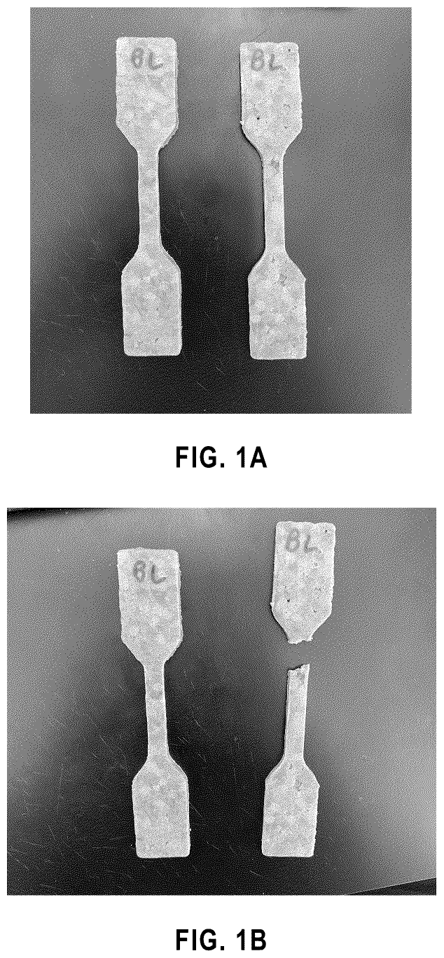

The tensile tests were performed by using a universal testing machine according to ASTM D638 (ASTM 2010). FIG. 1 shows a picture dog-bone shape prepared by compression molding for the tensile strength test.

The ultimate tensile strength (UTS), which represents the maximum stress the material can withstand before failure, was determined to be 10.83 MPa at 5.42% strain. This suggests that the material has significant load-bearing capacity before necking occurs. The fracture stress was observed at −0.33 MPa, which indicates a post-peak drop in stress leading to material failure at an extremely high strain.

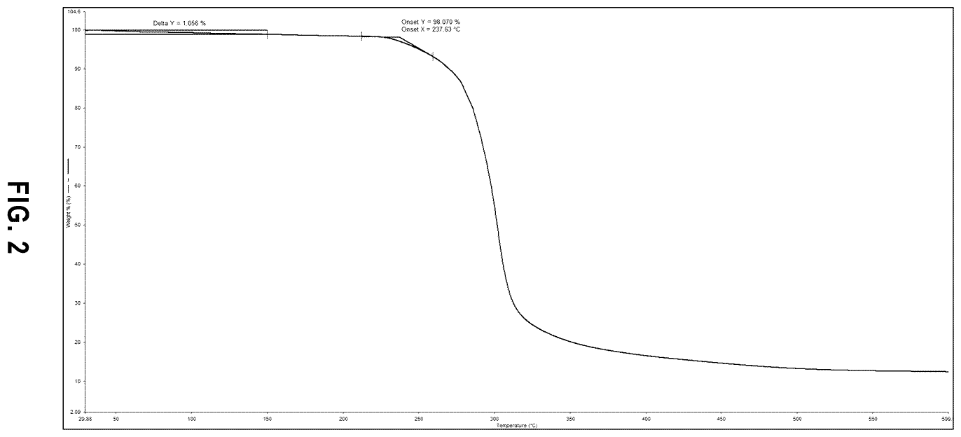

FIG. 2 is a thermogravimetric analysis (TGA) of extruded pellets after extrusion TGA curve, it shows that the material starts to degrade around 237.87° C., at a higher temperature.

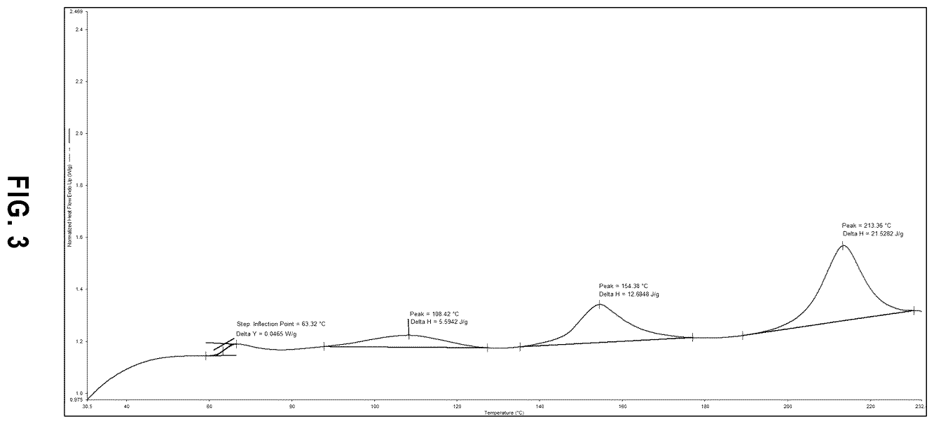

FIG. 3 is a Differential scanning calorimetry (DSC) graph that shows extruded pellets undergoing thermal transitions. The graph shows a material that softens at ~63° C., undergoes partial transitions at 109° C. and 154° C., and finally melts or decomposes at 213° C.

### Comparative Example 1

A bioplastic was prepared in the same manner as Example 1 except that it had the following composition:
seaweed alginate—50%,
PEG (plasticizer)—30%,
glycerol (plasticizer)—5%
calcium chloride (crosslinker)—10%, and
starch (additive)—5%

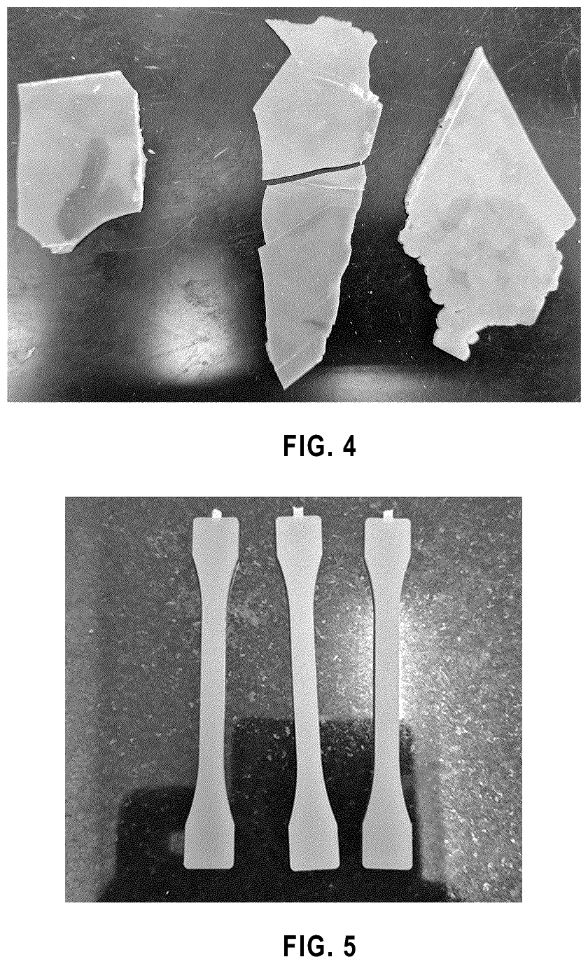

As can be seen in FIG. 4, this bioplastic was too brittle and could not be compression molded.

### Example 2

A bioplastic was prepared with the following composition:
seaweed alginate—30%,
PLA (plasticizer)—30%,
Hemp fiber—5%
Triethyl citrate (plasticizer)—10%
cellulose acetate (crosslinker)—15%, and
thermoplastic starch (additive)—10%.

These ingredients were mixed together and dried in an oven for 5-6 hours at 40° C. The mixture was added in a twin-screw extruder with extruder screw speed of 50, 75 and 90 C. The barrel temperature profile was die 165° C., Zone 2 170° C., Zone 3 165° C., Zone 4 170° C., Zone 5 180° C., Zone 6 175° C., Zone 7 165° C., and Zone 8 165° C.

The resulting bioplastic was injection molded for testing.

### Results

The Young's modulus was estimated to be 0.77 GPa (770 MPa). The tensile tests were performed by using a universal testing machine according to ASTM D638 (ASTM 2010). FIG. 5 shows a picture dog-bone shape prepared by injection molding for the tensile strength test.

The ultimate tensile strength (UTS) was determined to be 43.98 MPa at 8.22% strain. This suggests that the material has significant load-bearing capacity before necking occurs. These results indicate a balanced combination of strength and ductility, with consistent deformation behavior up to failure.

The scope of the claims should not be limited by the preferred embodiments set forth in the examples, but should be given the broadest interpretation consistent with the description as a whole.

### REFERENCES

The present description refers to a number of documents, the content of which is herein incorporated by reference in their entirety. These documents include, but are not limited to, the following:
U.S. Pat. No. 10,179,856B2
US20240101794A1
EP1075188B1
WO2022271496A1
US20230323095A1
WO2023083253A1
WO2021007579A1
Alvarez-Castillo, Rheology and Water Absorption Properties of Alginate-Soy Protein Composites, Polymers 2021, 13, 1807.
Hanry et al., Characterization of biofilms developed from alginate extracted from Padina sp. Incorporated with calcium chloride (CaCl₂), 2022 J. Phys.: Conf. Ser. 2314 012022

1. A thermoplastic water-free solvent-free bioplastic composition comprising:
a seaweed alginate, at least one plasticizer, and at least one crosslinker.

2. The composition of claim 1, being free of liquids.

3. The composition of claim 1, comprising the seaweed alginate in:
a concentration of at least about 10 wt/wt %, preferably at least about 15 wt/wt %, more preferably at least about 20 wt/wt %, and yet more preferably at least about 25 wt/wt %, based on the total weight of the composition; and/or
a concentration of at most about 70 wt/wt %, preferably at most about 60 wt/wt %, more preferably at most about 50 wt/wt %, yet more preferably at most about 40 wt/wt %, and even more preferably at most about 35 wt/wt %, based on the total weight of the composition; and/or
a concentration between about 25 wt/wt % and about 35 wt/wt %, preferably a concentration of about 30 wt/wt %, based on the total weight of the composition.

4. The composition of claim 1, wherein the plasticizer is glycerol, diglycerol, glycerol monoacetate, glycerol diacetate, sorbitol, sorbitan, mannitol, 1,3-propanediol, 1,2,3-hexanetriol, butanediol, butanetriol, ethylene glycol, polyethylene glycol (PEG), propylene glycol, polybutylene adipate-co-terephthalate (PBAT), polybutylene succinate (PBS), polycaprolactone (PCL), polybutylene succinate adipate (PBSA), Polyhydroxyalkanoates (PHA), 1,3-trimethylene glycol, triethyl citrate, urea, polylactic acid (PLA), microcrystalline cellulose, seaweed nano cellulose, rice husk powder, acacia gum, algae oil, coconut oil, an ester gum, palm stearin, or a thermoplastic cellulose ether, or a mixture thereof; preferably the plasticizer is PLA or PEG (preferably PLA) or a mixture of A) PEG or PLA (preferably PLA) with B) triethyl citrate or glycerol (preferably triethyl citrate).

5. The composition of claim 1, wherein the mixture of PLA with triethyl citrate (TC) has a PLA: TC weight ratio of about 2:1 to about 4:1, preferably about 3:1.

6. The composition of claim 1, comprising the plasticizer:
in a concentration of at least about 5 wt/wt %, preferably at least about 10 wt/wt %, more preferably at least about 15 wt/wt %, yet more preferably at least about 20 wt/wt %, even more preferably at least about 25 wt/wt %, more preferably at least about 30 wt/wt %, yet more preferably at least about 35 wt/wt %, and most preferably at least about 40 wt/wt %, based on the weight of the composition; and/or
in a concentration of at least about 5 wt/wt %, preferably at least about 10 wt/wt %, more preferably at least about 15 wt/wt %, yet more preferably at least about 20 wt/wt %, even more preferably at least about 25 wt/wt %, more preferably at least about 30 wt/wt %, yet more preferably at least about 35 wt/wt %, and most preferably at least about 40 wt/wt %, based on the weight of the composition; and/or
in a concentration between about 35 wt/wt % and about 45 wt/wt %, preferably a concentration of about 40 wt/wt %, based on the weight of the composition.

7. The composition of claim 1, wherein the crosslinker is a metal salt or a metal salt hydrate, or a mixture thereof; preferably a metal chloride, a metal carbonate salt, a metal nitrate salt, a metal lactate salt, a metal oxalate salt, a metal acetate salt, an hydrate of these salts, or a mixture thereof; more preferably CaCl₂, CaCl₂·2H₂O, Ca(NO₃)₂·4H₂O, CaSO₄·2H₂O, AlK(SO₄)₂·12H₂O, or a mixture thereof; preferably CaCl₂ or calcium acetate, and most preferably calcium acetate; or alternatively preferably CaCl₂.

8. The composition of claim 1, comprising the crosslinker:
in a concentration of at least about 2 wt/wt %, preferably at least about 5 wt/wt %, more preferably at least about 10 wt/wt %, yet more preferably at least about 12.5 wt/wt %, and most preferably at least about 15 wt/wt %, based on the total weight of the composition
in a concentration of at most about 20 wt/wt %, preferably at most about 17.5 wt/wt %, and more preferably at most about 15 wt/wt %, based on the total weight of the composition; and/or in a concentration between about 12.5 wt/wt % and about 17.5 wt/wt %, preferably a concentration of about 15 wt/wt %, based on the weight of the composition.

9. The composition of claim 1, further comprising a reinforcement fiber; preferably natural fibers, more preferably cellulosic fibers, yet more preferably hemp fibers, jute fibers, sisal fibers, citrus fibers, flax fibers, bamboo fibers, or a mixture thereof, even more preferably hemp fibers or flax fibers, and most preferably hemp.

10. The composition of claim 1, comprising the reinforcement fiber:
in a concentration of at least about 2.5 wt/wt %, preferably at least about 5 wt/wt %, based on the total weight of the composition; and/or
in a concentration of at most about 20 wt/wt %, preferably at most about 15 wt/wt %, more preferably at most about 10 wt/wt %, yet more preferably at most about 7.5 wt/wt %, and most preferably at most about 5 wt/wt %, based on the total weight of the composition; and/or
in a concentration between about 2.5 wt/wt % and about 7.5 wt/wt %, preferably a concentration of about 5 wt/wt %, based on the weight of the composition.

11. The composition of claim 1, further comprising one or more additives.

12. The composition of claim 11, wherein the one or more additives is a starch, preferably thermoplastic starch, microcrystalline cellulose (MCC), guar gum, carboxymethyl cellulose (CMC), a mineral salt, calcium carbonate, calcium carbonate hydrate, or a mixture thereof.

13. The composition of claim 11, wherein the one or more additives is a starch, preferably thermoplastic starch.

14. The composition of claim 11, comprising said one or more additives:
in a total concentration of at most about 20 wt/wt %, preferably at most about 15 wt/wt %, more preferably at most about 12.5 wt/wt %, and yet more preferably at most about 10 wt/wt %, based on the total weight of the composition; and/or
in a total concentration of at least about 2.5 wt/wt %, preferably at least about 5 wt/wt %, more preferably at least about 7.5 wt/wt %, and yet more preferably at least about 10 wt/wt %, based on the total weight of the composition; and/or
in a total concentration between about 7.5 wt/wt % and about 12.5 wt/wt %, preferably at a concentration of about 10 wt/wt %, based on the total weight of the composition.

15. The composition of claim 1, being free of microcrystalline cellulose (MCC), guar gum, carboxymethyl cellulose (CMC), a mineral salt, calcium carbonate, calcium carbonate hydrate, or a mixture thereof.

16. The composition of claim 1, wherein the composition of the invention is free of one or more, preferably all of the following:
soy protein isolate, more generally any plant proteins, and yet more generally any protein,
a starch
seaweed nanocellulose, and/or
a cellulose ether linked to the seaweed alginate or another cellulose ether.

17. A method of manufacturing the composition of claim 1, the method comprising the steps of:
A) mixing together:
the seaweed alginate,
the at least one plasticizer,
the at least one crosslinker,
optionally, the at least one lubricant,
optionally, the reinforcement fiber, and
optionally, the one or more additives,
thus producing a mixture of powders, and
B) carrying out a reactive extrusion of the mixture of powders.

18. The method of claim 17, being carried out in the absence of water.

19. The method of claim 17, being carried out in the absence of a solvent.

20. The method of claim 17, being carried out in the absence of liquids.
